(19) United States
(12) Patent Application Publication
(10) Pub. No.: US 2002/0143581 A1
(43) Pub. Date: Oct. 3, 2002

(54) Operating information management apparatus and operating information management program storage medium

(75) Inventor: Masamichi Ishii, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/107,320

(22) Filed: Mar. 28, 2002

(30) Foreign Application Priority Data
Mar. 28, 2001 (JP) 2001-093037

(51) Int. Cl. G06F 17/60

(52) U.S. Cl. 705/2

(57) ABSTRACT

An operating information management apparatus includes a set master storage unit 142 storing an information set including article information and practice information, an information input unit 121 receiving an input of article information, a retrieval unit 122 retrieving an information set of the set master storage unit 142 by using inputted article information as a key, and an operating information creation unit 125 creating operating information based on the set found in retrieval.

### BACKGROUND OF THE INVENTION

1. Field of the Invention

The present invention relates to an operating information management apparatus that manages operating information showing the contents of operation of a medical practice, and to an operating information management program storage medium that stores the operating information management program that is built in a computer and makes the computer operate as an operating information management apparatus.

2. Description of the Related Art

In recent years, also in medical institutions, various document preparation devices and information management systems using computers have become widespread. As a kind of those devices, an operating information management apparatus is proposed, the operating information management apparatus that records and manages as electronic information the contents of operation of a medical practice that an office staff or the like of a hospital manually records and manages conventionally by using a voucher that a medical practicer produced. When this operating information management apparatus is introduced, it is expected that the increase in efficiency and accuracy of office work about a medical remuneration claim etc. in a hospital will be realized.

In such an operating information management apparatus, it is necessary that practice information showing an operated medical practice, and article information showing a consumable, is inputted. It is desirable that such information is inputted by a medical practicer such as a medical doctor or a nursing staff when the medical practice is operated. That is, an input of information in a medical site is demanded of medical practicers.

However, there is a problem that, when a medical practicer inputs practice information and article information in a busy medical site, the medical practicer has many burdens naturally, and hence, the medical practicer easily produces an input mistake.

Then, an operating information management apparatus in which such devices that information is selectively inputted from a selection menu by using a mouse or article information is inputted by reading a bar code attached to an article by using a bar code reader and which mitigates the burdens of a medical practicer are given is also proposed. However, even if such devices are given, there is a high possibility that article information on a used article etc. may be inputted in a batch after first-aid treatment etc. in a site of emergency medical treatment, and there is also a high possibility of lacking informational to be inputted. For this reason, there is a possibility that inaccurate operating information may be recorded.

In addition, generally, the practice information and article information which should be managed with an operating information management apparatus are limited to information on some medical practices or articles among various medical practices and articles in a medical institution such as a hospital. For example, there is such a case that, although article information on an article that medical remuneration can be claimed is an object for management, the article information on the article is not managed by the operating information management apparatus if medical remuneration can be claimed only about a medical practice even if it is an article consumed in connection with the medical practice. Thus, when an object for management is limited, a medical practicer such as a medical doctor or a nursing staff needs to determine appropriately whether it is an object for management in an operating information management apparatus, and needs to input information, at the time of an information input. However, in order to determine an object for management, the newest knowledge about the insurance institution etc. revised every year is required and knowledge beyond the knowledge about operation of medical practices which are originally required of medical practicers is required, and hence, this result in forcing the medical practicers serious burdens on business.

### SUMMARY OF THE INVENTION

In consideration of the above-described situation, the present invention aims at providing an operating information management apparatus which can easily create operating information appropriately including information on an article which should be managed, and an operating information management program storage medium where an operating information management program which makes a computer operate as an operating information management apparatus is stored.

An operating information management apparatus that achieves the above-described object is an operating information management apparatus that manages operating information showing operation contents of a medical practice, comprising:

an information set storage unit storing an information set including the practice information showing a medical practice, and article information showing the article consumed in connection with the medical practice;

an article information input unit into which arbitrary article information showing an article consumed in connection with a medical practice is inputted;

an information set retrieval unit retrieving an information set including the same article information as the article information inputted into the article information input unit among information sets stored in the above-described information set storage unit; and

an operating information creating unit creating the operating information based on article information and practice information which are included in an information set retrieved by the above-described information set retrieval unit.

According to the operating information management apparatus of the present invention, since the operating information is created on the basis of article information and practice information which are included in an information set, suitable operating information is created by information on an article etc., which is an object for management. adequately being prepared beforehand as an information set. For this reason, the operating information management apparatus according to the present invention can greatly contribute to increase in efficiency and accuracy of office work.

In addition, according to the operating information management apparatus of the present invention, since an information set is retrieved by the information set retrieval unit and operating information is created so long as article information about some articles out of used articles is inputted into the article information input unit, it is possible to easily create adequate operating information including sufficient article information etc. Therefore, it is possible that a medical doctor, a nursing staff, etc. who are users of the operating information management apparatus can easily create operating information without being disturbed about operating activities of a medical practice which are original activities.

It is preferable that an operating information management apparatus of the present invention further comprises:

a practice information acquisition unit acquiring the practice information from a predetermined information source; and

a practice information collating unit collating practice information included in an information set retrieved by the information set retrieval unit with practice information acquired by the practice information acquisition unit.

Here, a “predetermined information source” may be an information source of practice information showing a medical practice that will be practiced, or may be an information source of practice information showing a medical practice that has been already practiced.

In an information set found in retrieval by the information set retrieval unit, there is a possibility that also an information set including practice information etc. showing a medical practice that is not planned, and practice information showing a medical practice that has been already finished and for which practice information has been already created may be included. Although an information set including such practice information may become a cause that wrong operating information is created, it is possible to easily avoid the creation of such wrong operating information and to create accurate operating information by the above-described practice information collating unit collating the practice information.

In addition, it is preferable that an operating information management apparatus according to the present invention further comprises an information extraction unit extracting at least either one of article information and practice information that show an article and a medical practice respectively for which remuneration can be claimed from article information and practice information that are included in an information set retrieved by the information set retrieval unit.

Generally, although a medical practice and article that are objects for management in the operating information management apparatus are a medical practice and an article that can claim medical remuneration, it is not always possible to claim medical remuneration about all the objects for management. In addition, knowledge such as an insurance institution is required for proper determination of whether the medical remuneration can be claimed or not.

Then, if the information extraction unit that extracts what can claim the medical remuneration out of the operating information on the basis of a convention and the like of the insurance institution, it is very convenient for accurate office work.

In order to achieve the above-described object, an operating information management program storage medium according to the present invention that stores an operating information management program that is built in a computer and makes the computer operate as an operating information management apparatus which manages operating information showing operation contents of a medical practice, is characterized in that the operating information management program storage medium stores an operating information management program which makes a computer operate as an operating information management apparatus that comprises the above-described information set storage unit, the above-described article information input unit, the above-described information set retrieval unit; and the above-described operating information creation unit.

In addition, although only the fundamental form is shown here about the operating information management program according to the present invention, this is only for avoiding duplication, and hence, the operating information management program according to the present invention includes not only the operating information management program in the above-described fundamental form, but also various types of operating information management programs corresponding to respective forms of the above-described operating information management apparatus.

### BRIEF DESCRIPTION OF THE DRAWINGS

FIG. 1 is an external view showing a computer network in which an embodiment of an operating information management apparatus according to the present invention is built in as a server.

FIG. 2 is a hardware structural diagram of an embodiment of the operating information management apparatus (server machine) according to the present invention.

FIG. 3 is a functional block diagram showing an embodiment of an operating information management apparatus according to the present invention.

FIGS. 4A to 4C are drawings showing examples of item masters.

FIG. 5 is a diagram showing an example of a set master.

FIGS. 6A and 6B are diagrams showing each example of a set name master and a master class.

FIG. 7 is a diagram showing an example of patient information inputted into the operating information management apparatus.

FIG. 8 is a diagram showing an example of article information inputted into the operating information management apparatus.

FIG. 9 is a diagram showing an example of operating information created in the operating information management apparatus.

FIG. 10 is a diagram showing another example of article information inputted into the operating information management apparatus.

FIG. 11 is a diagram showing items read into an information check unit.

FIG. 12 is a diagram showing an example of schedule information.

FIG. 13 is a diagram showing an example of items selected by the information check unit.

FIG. 14 is a diagram showing an example of operating information created in a first application operation.

FIG. 15 is a diagram showing another example of schedule information.

FIG. 16 is a diagram showing another example of items selected by the information check unit.

FIG. 17 is a diagram showing an example of created operating information.

FIG. 18 is a diagram showing a list of disease names.

FIG. 19 is a diagram showing an example of a check master.

FIG. 20 is a diagram showing an example of records read from the check master.

FIG. 21 is a diagram showing the evaluation result of a set.

FIGS. 22A to 22C are diagrams showing examples of medical linkage information.

FIG. 23 is a diagram showing an example of operating information read into the accounting information processing unit.

FIG. 24 is a diagram showing an example of medical accounting supply information.

### DETAILED DESCRIPTION OF THE PREFERRED EMBODIMENTS

Hereafter, embodiments of the present invention will be described.

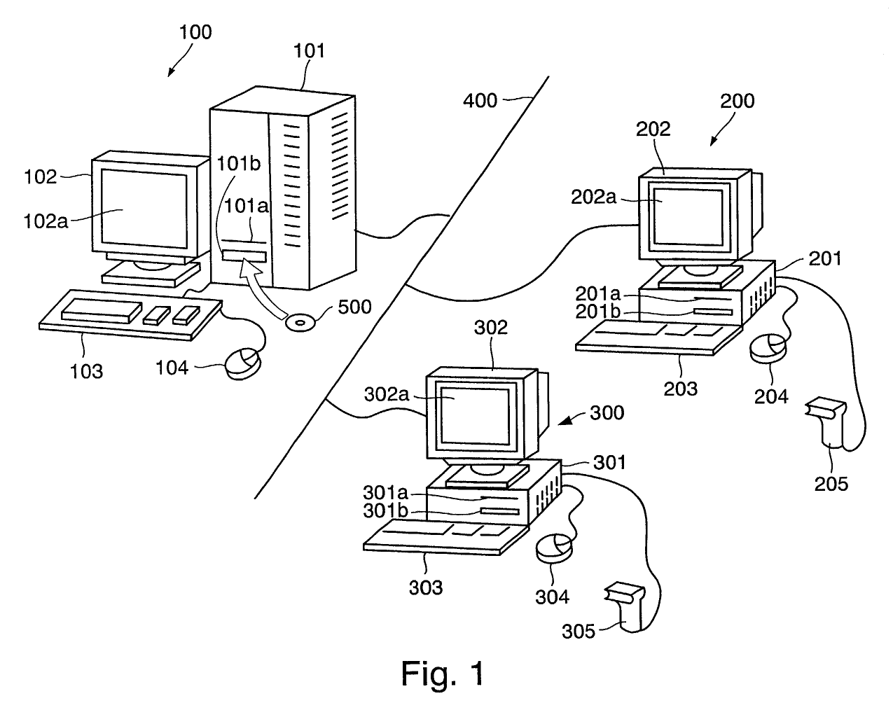

FIG. 1 is an external view showing a computer network in which an embodiment of an operating information management apparatus according to the present invention is built in as a server.

Here, three computers are shown as an example, one computer among these computers is a server machine installed in a hospital as an operating information management apparatus 100, and other two computers are personal computers installed as terminals 200 and 300 that are used by a medical doctor or a nursing staff so as to use the operating information management apparatus 100. These operating information management apparatus 100 and terminals 200 and 300 are mutually connected through a LAN (Local Area Network) 400 provided in the hospital. In addition, although a server machine operates as an embodiment of the operating information management apparatus according to the present invention here, the operating information management apparatus according to the present invention may be constituted by a computer network including a plurality of computers. For convenience of explanation, assuming that one server machine corresponds to an embodiment of the operating information management apparatus according to the present invention, explanation will be performed below.

Computers which constitute respective operating information management apparatus 100 and terminals 200 and 300 that are shown in FIG. 1 comprise: main units 101, 201, and 301 in each of which a CPU, main storage device, a hard disk, a communication board, etc. are built in; display units 102, 202, and 302 which display each image and/or each character string on display screens 102a, 202a, and 302a by each command from the main units 101, 201, and 301; keyboards 103, 203, and 303 for inputting each user's command into the operating information management apparatus 100 and the terminal 200 and 300; and mice 104, 204, and 304 for inputting each command according to icons etc. displayed on a position at the time of pointing by pointing each arbitrary position on the display screens 102a, 202a, and 302a.

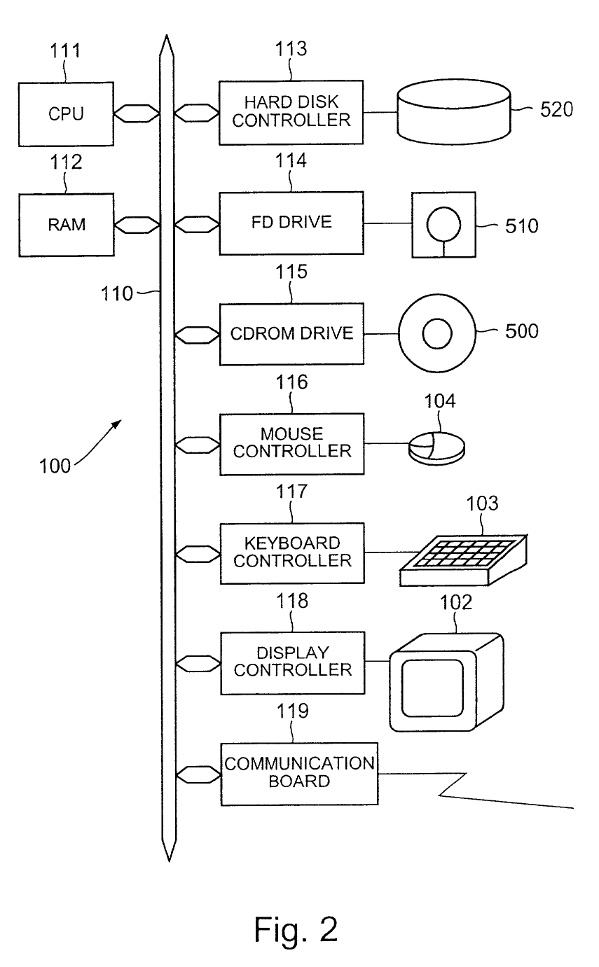

In addition, respective main units 101, 201, and 301 further comprise FD loading slots 101a, 201a, and 301a and CDROM loading slots 101b, 201b, and 301b, where each floppy (trademark) disk (not shown in FIG. 1: refer to FIG. 2), and each CDROM 500 are loaded, in appearance. Inside those, each FD drive and each CDROM drive which drive and access each floppy (trademark) disk and CDROM 500 that are loaded from those loading slots and loading slots 101a and 101b; 201a and 201b; 301a and 301b are also built in.

In addition, computers as the terminals 200 and 300 also comprise bar code readers 205 and 305, which read bar codes appended to articles, respectively.

Here, an embodiment of the operating information management program according to the present invention is stored in the CDROM 500, this CDROM 500 is loaded into the main unit 101 of a server machine from the CDROM loading slot 101b, and an operating information management program stored in the CDROM 500 is installed in the hard disk of this server machine by the CDROM drive. When the operating information management program installed in this hard disk is started, this server machine operates as an embodiment of the operating information management apparatus according to the present invention.

Therefore, the CDROM 500 where the operating information management program is stored is equivalent to an embodiment of an operating information management program storage medium according to the present invention.

In addition, although the operating information management program stored in this CDROM 500 is installed in the hard disk of the computer as described above, the hard disk in the status that the operating information management program is installed is also equivalent to an embodiment of the operating information management program storage medium according to the present invention.

Furthermore, when the operating information management program is downloaded on a floppy (trademark) disk, the floppy (trademark) disk in the status that the downloaded operating information management program is stored is also equivalent to an embodiment of the operating information management program storage medium according to the present invention.

FIG. 2 is a hardware structural diagram of an embodiment of the operating information management apparatus (server machine) according to the present invention.

This operating information management apparatus 100 comprises a central processing unit (CPU) 111, RAM 112, a hard disk controller 113, an FD drive 114, a CDROM drive 115, a mouse controller 116, a keyboard controller 117, a display controller 118, and a communication board 119, which are mutually connected via a bus 110.

As described with reference to FIG. 1, the FD drive 114 and the CDROM drive 115 where the floppy (trademark) disk 510 and CDROM 500 are loaded respectively access the floppy (trademark) disk 510 and CDROM 500, which are loaded, respectively.

The communication board 119 is connected to the LAN 400 shown in FIG. 1, and communicates through the LAN 400.

In addition, here, a hard disk 520 accessed by the hard disk controller 113, the mouse 104 controlled by the mouse controller 116, the keyboard 103 controlled by the keyboard controller 117, and the display unit 102 controlled by the display controller 118 are also shown.

As described above, the embodiment of the operating information management program according to the present invention is stored in the CDROM 500, and the operating information management program is read from the CDROM 500 by the CDROM drive 115 and is stored in the hard disk 520 by the hard disk controller 113 via the bus 110. In actual execution, the operating information management program in the hard disk 520 is loaded in the RAM 112 and is executed by the CPU 111.

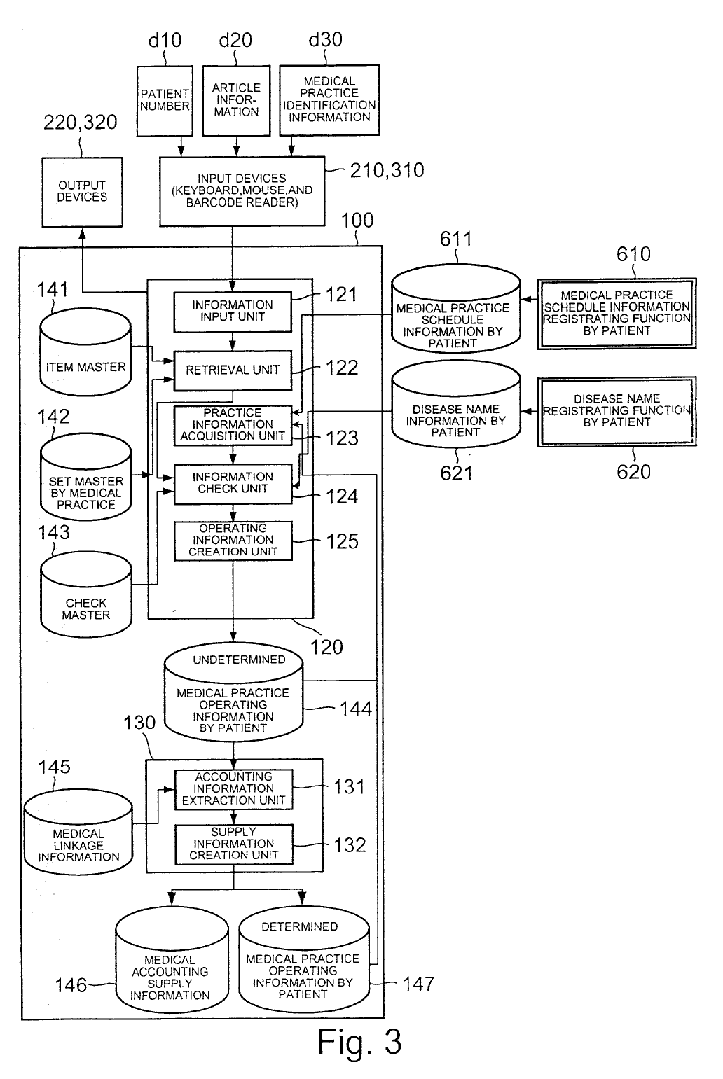

FIG. 3 is a functional block diagram showing an embodiment of the operating information management apparatus according to the present invention.

This operating information management apparatus 100 is equipped with an operating information processing unit 120 and an accounting information processing unit 130. The operating information processing unit 120 processes information about the contents of operation of a medical practice, and the accounting information processing unit 130 processes medical accounting information.

This operating information processing unit 120 receives inputs through input devices (a keyboard, a mouse, and a bar code reader) 210 and 310 of the above-described terminals 200 and 300, and via the LAN 400. In addition, this operating information processing unit 120 performs outputs through output devices (display units and printers) 220 and 320 of the terminals 200 and 300, which are described above, if necessary.

This operating information management apparatus 100 also comprises an item master storage unit 141, a set master storage unit 142, and a check master storage unit 143. An item master where items of medical practices and articles that are managed by this operating information management apparatus 100 are mentioned in a list is stored in the item master storage unit 141. In addition, a set master where sets of the items stored in the item master storage unit 141 are mentioned in a list is stored in the set master storage unit 142. As described in detail later, this set master storage unit 142 is equivalent to an example of the information set storage unit in the present invention. In addition, a check master where indices for checking the content of information processed in the operating information processing unit 120 from a medical viewpoint are mentioned is stored in the check master storage unit 143. The operating information processing unit 120 suitably reads each of the stored contents of these item master storage unit 141, set master storage unit 142, and check master storage unit 143, and uses it for information processing.

In addition, the operating information processing unit 120 acquires schedule information showing a schedule of a medical practice from a schedule information storage apparatus 611 through the above-described LAN 400. This schedule information storage apparatus 611 is equivalent to an example of an information source in the present invention. The schedule information is registered every patient into the schedule information storage apparatus 611 by a schedule information registration function 610 which a predetermined computer connected to the LAN bears.

Furthermore, this operating information processing unit 120 acquires disease name information, showing a disease that a patient caught, from a disease name information storage apparatus 621 through the above-described LAN 400. This disease name information storage apparatus 621 is also equivalent to an example of the information source in the present invention. The disease name information is registered every patient into the disease name information storage apparatus 621 by a disease name registration function 620 which a predetermined computer connected to the LAN bears.

This operating information processing unit 120 is equipped with an information input unit 121, a retrieval unit 122, a practice information acquisition unit 123, an information check unit 124, and an operating information creation unit 125.

The information input unit 121 is an example of the article information input unit in the present invention, and receives an input of a patient number d10, article information d20, and medical practice identification information d30 through the input devices 210 and 310 of the terminals described above. Here, the medical practice identification information d30 is information different from the practice information described above, and is information specifying a desired set out of the sets that are stored in the set master storage unit 142.

The retrieval unit 122 is an example of the information set retrieval unit in the present invention, and retrieves a set including the same article information as the inputted article information d20 as an item and reads a set specified by the medical practice identification information d30 by accessing the item master storage unit 141 and the set master storage unit 142.

The practice information acquisition unit 123 is an example of the practice information acquisition unit in the present invention, and acquires practice information showing a medical practice planned, and practice information showing a medical practice having been already finished.

The information check unit 124 is an example of the practice information collating unit in the present invention, and collates practice information acquired in the practice information acquisition unit 123 with practice information included in the retrieved set. In addition, this information check unit 124 also performs a medical information check on the basis of the check master stored in the check master storage unit 143.

The operating information creation unit 125 is an example of the operating information creation unit in the present invention, and creates operating information by using the checked practice information and the like. The created operating information is stored in a first operating information storage unit 144 as undetermined operating information.

As described above, the accounting information processing unit 130 processes medical accounting information, and comprises an accounting information extraction unit 131 and a supply information creation unit 132. In addition, this accounting information processing unit 130 acquires information required for a medical remuneration claim in regard to a medical practice or a consumable from a medical linkage information storage unit 145.

The accounting information extraction unit 131 is an example of the information extraction unit in the present invention, and extracts practice information and article information, for which a medical remuneration can be claimed, out of the practice information and article information that are included in the undetermined operating information.

The supply information creation unit 132 makes undetermined operating information confirmed while creating medical accounting supply information by using practice information and article information which are extracted in the accounting information extraction unit 131. The created medical accounting supply information is stored in a supply information storage unit 146. In addition, the confirmed operating information is stored in a second operating information storage unit 147.

Hereafter, the operation and the like of the operating information management apparatus 100 will be described in detail.

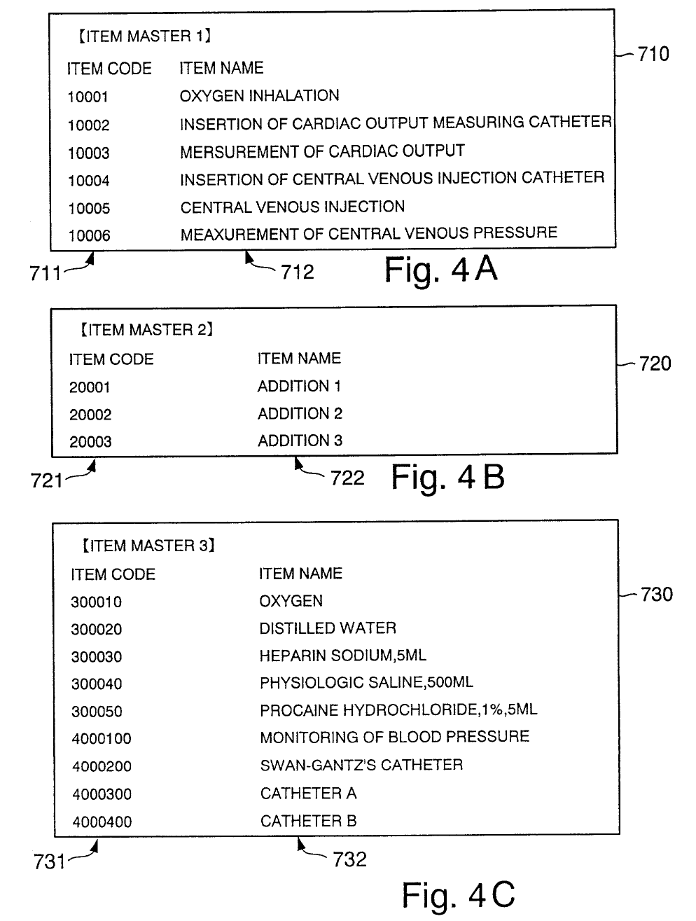

FIGS. 4A to 4C are drawings showing examples of item masters.

These FIGS. 4A to 4C show three item masters, that is, FIG. 4A shows a medical practice (manipulation) item master 710, FIG. 4B shows a medical remuneration addition item master 720, and FIG. 4C shows an article item master 730. In this embodiment, these three item masters 710, 720, and 730 are stored in the item master storage unit 141 shown in FIG. 3.

These three item masters 710, 720, and 730 show items of medical practices and articles, which are processing-objects in the operating information management apparatus, in a list format. In these three item masters 710, 720, and 730, item codes 711, 721, and 731 showing items of a medical practice and an article, and item names 712, 722, and 732 shown by the item codes 711, 721, and 731 are mentioned with being mutually associated. This item code shows a medical practice and an article, which are classified into an item, while showing the item. Therefore, the item code specifying a medical practice is equivalent to the practice information in the present invention, and the item code specifying an article is equivalent to the article information in the present invention.

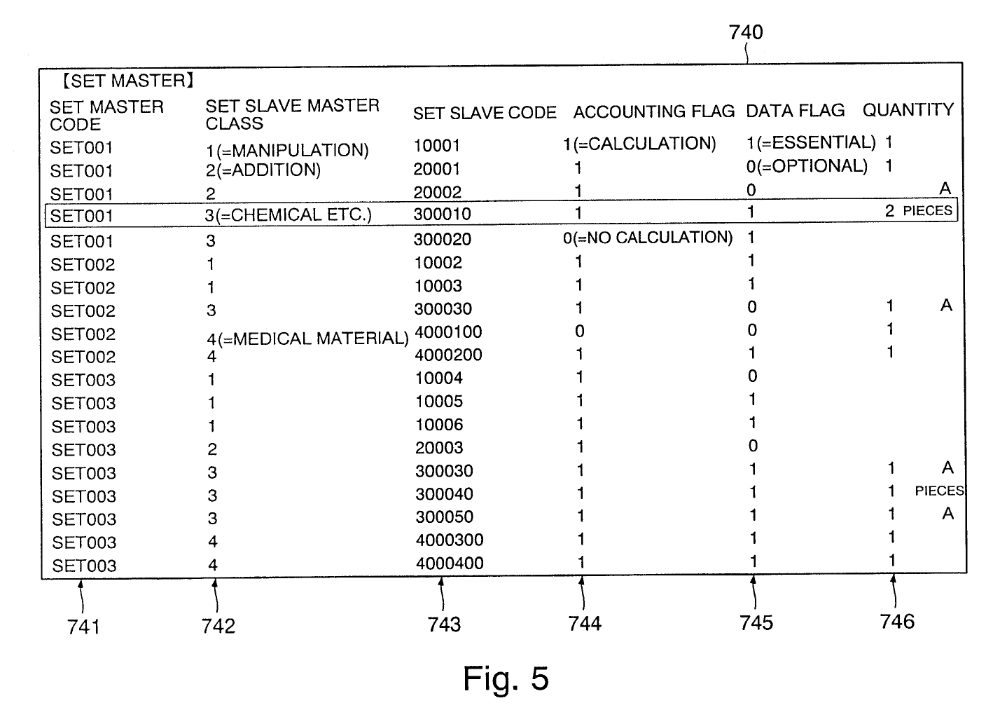

FIG. 5 is a diagram showing an example of a set master.

This set master 740 shows sets of items of a medical practice and an article in a list format, and is stored in the set master storage unit 142 shown in FIG. 3.

In each line of this set master 740, one combination of a set master code 741 specifying a set, and a set slave code 743 showing an item included in the set is mentioned. This set slave code 743 is selected from the item codes 711, 721, and 731 shown in FIG. 4, and is mentioned. One line (namely, one record) of this set master 740 corresponds to an item of one medical practice or one article, and one set is shown by a plurality of lines where the same set master code 741 is mentioned. Many sets are prepared beforehand for an operating information management apparatus, and are stored.

A set that this set master 740 shows is prepared according to an embodiment of a medical practice in a medical site, and a plurality of medical practice items may be included in one set. For example, a series of medical practices in an operation of a specific body part are summarized in one set.

In the set master 740, a set slave master class 742, an accounting flag 744, a data flag 745, and quantity 746 are also mentioned with being associated with a combination of the set master code 741 and set slave code 743 which are described above.

The set slave master class 742 shows a class of an item master where an item code to which the set slave code 743 corresponds is mentioned. A set slave master class 742 having a value “1” denotes a class “manipulation”, a set slave master class 742 having a value “2” denotes a class “addition”, a set slave master class 742 having a value “3” denotes a class “chemical etc.”, and a set slave master class 742 having a value “4” denotes a class “medical material”.

An accounting flag 744 denotes whether the medical practice or article of an item that a set slave code 743 denotes is an object to be calculated as a claim object of medical remuneration. An accounting flag 744 having a value “1” denotes “calculation”, and an accounting flag 744 having a value “0” denotes “no calculation”.

A data flag 745 denotes whether an item to which the line where the data flag 745 is mentioned corresponds is an indispensable item in the operation of the medical practice in a medical site or it is an arbitrarily selectable medical practice or article. A data flag 745 having a value “1” denotes that an item corresponding to it is an indispensable item, and a data flag 745 having a value “0” denotes that an item corresponding to it is an arbitrary item.

Quantity 746 denotes the standard consumption of an article.

The set master storage unit 142 shown in FIG. 3 also stores a set name master showing a set name in a list format, and a list of classes of the above-described item master besides this set master 740.

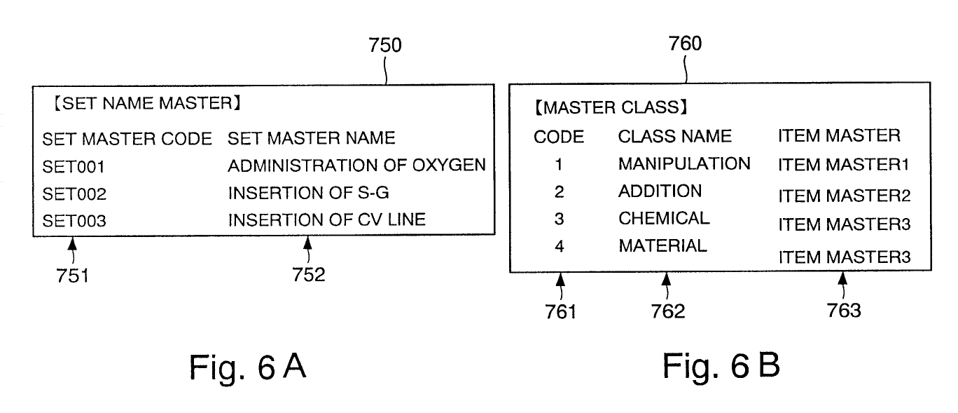

FIGS. 6A and 6B are diagrams showing each example of a set name master and a master class.

FIG. 6A shows a set name master 750, and FIG. 6B shows an item class list 760 of an item master.

In this embodiment, a name that a user can easily use is assigned to each item set. In the set name master 750, a set master code 751 specifying a set, and a name 752 of a set specified by the set master code 751 are mentioned while being associated mutually.

In addition, in this embodiment, since the item masters 710, 720, and 730 shown in FIG. 4 and the set master 740 shown in FIG. 5 are indirectly associated through classes of the item masters, a degree of freedom of association of the item masters 710, 720, and 730 with the set master 740 is enhanced. In the master class list 760, a code number 761 showing a master class, a class name 762, and a name 763 of an item master belonging to a class are mutually associated and mentioned. In this embodiment, as an example, the item master 710 in FIG. 4A is associated with a class “manipulation”, the item master 720 in FIG. 4B is associated with a class “addition”, and the item master 730 in FIG. 4C is associated with each of classes “chemical” and “material”.

Hereafter, the operation of the operating information management apparatus according to this embodiment will be described.

First, the fundamental operation of the operating information management apparatus will be described.

When a medical practice is performed by a medical doctor or a nursing staff who is a user of the operating information management apparatus and the operating information management apparatus is started by the user, an input column for patient selection is displayed on the display units 202 and 203 shown in FIGS. 1 and 2, and an input of patient information specifying a patient is prompted.

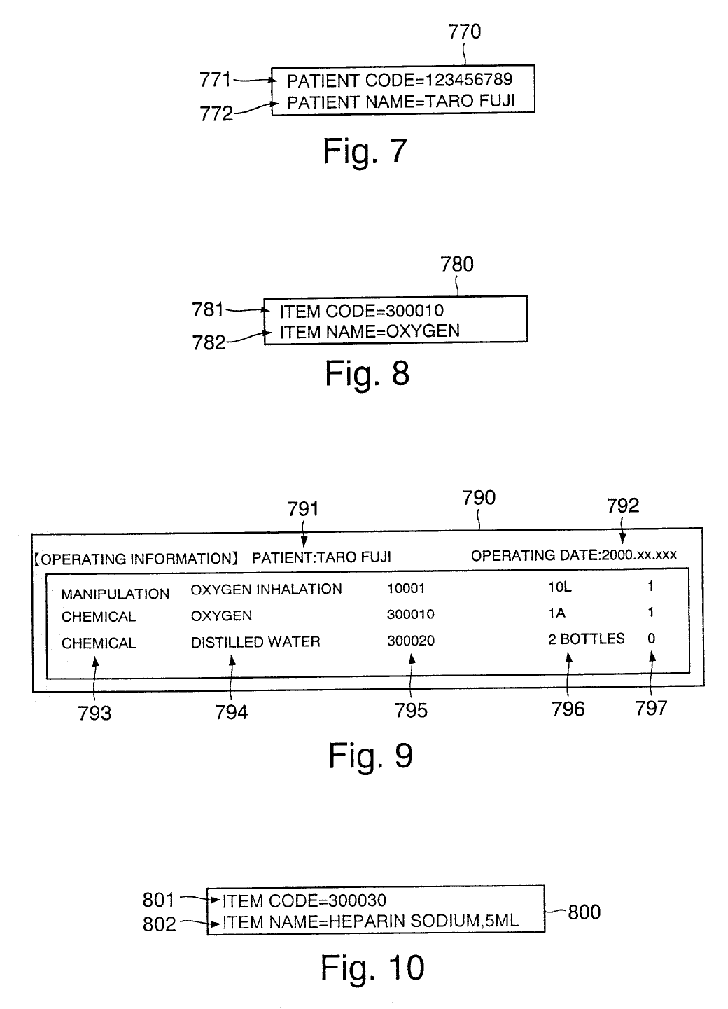

FIG. 7 is a diagram showing an example of inputted patient information.

Patient information 770 consists of a patient code field 771 and a patient name 772 that are equivalent to a patient number d10 shown in FIG. 3. The patient information 770 which consists of a patient code “123456789” and a patient name “Taro Fuji” is shown in this FIG. 7 as an example.

After inputting the patient information specifying the patient for whom the medical practice was performed, a medical doctor or a nursing staff inputs article information by using a bar code reader etc. or inputs medical practice identification information by using a keyboard or a mouse.

As described above, the medical practice identification information is the information specifying a set, and an input operation of the medical practice identification information is an operation by menu selection that is the same as that in a conventional operating information management apparatus. This input operation is convenient when a medical doctor or a nursing staff knows a target set, corresponding to a medical practice performed, among many sets. A set is specified by medical practice identification information when the medical practice identification information is inputted.

On the other hand, when article information is inputted, a set is retrieved as described below.

FIG. 8 is a diagram showing an example of inputted article information.

As article information showing an article, article information 780 that consisted of a pair of an item code 781 and an item name 782 is inputted here. This article information 780 is inputted into the information input unit 121, which is shown in FIG. 3, by a bar code reader reading a bar code attached to the article.

In addition, as a specific example of the article information, FIG. 8 shows the article information 780 which consists of an item code “300010” and an item name “oxygen”.

An item set is retrieved by the retrieval unit 122 when such article information 780 is inputted into the information input unit 121 shown in FIG. 3. This retrieval is performed as describe below by using the set master 740 shown in FIG. 5.

A set slave code 743 coinciding with the item code (here “300010”) which constitutes the article information inputted into the information input unit 121 among the set slave codes 743 mentioned in each line of the set master 740 is retrieved. Then, the set master code 741 (here “SET001”) of the same line as the line where the set slave code 743 found in retrieval is mentioned is acquired. This means that the set specified by the set master code 741 is retrieved. The set found by retrieval is sent to the operating information creation unit 125 through a below-described check by the information check unit 124 shown in FIG. 3 while being shown to a user through the output devices 220 and 320 shown in FIG. 3.

Here, an example in which one set is found as a result of retrieval of the set is shown, and the set to correspond to the performed medical practice is specified.

On the other hand, when the a plurality of sets is found as a result of retrieval of the set, the operating information creation unit 125 prompts the medical doctor or nursing staff, who is a user of the operating information management apparatus 100, to select a set, and a target set is specified by the selecting operation.

Thus, when the target set is specified by retrieval or user's selection, the operating information creation unit 125 extracts an item of the medical practice or article, which is included in the target set, from the set master 740 shown in FIG. 5. And, the operating information creation unit 125 prompts a user a selection operation whether or not it is necessary for an item having the value of a data flag 745 “0” among extracted items. By the selecting operation, the item of the actually performed medical practice or article is specified. After that, the operating information on the basis of the set whose item is specified is created by the operating information creation unit 125, and is stored in the first operating information storage unit 144 while the user is shown the operating information through the output devices 220 and 320 shown in FIG. 3.

FIG. 9 is a diagram showing an example of created operating information.

The operating information 790 shown in this FIG. 9 is constituted by a patient name 791 that is quoted from the patient name 772 shown in FIG. 7, a date 792 of a day when a medical practice is performed, a class name 793 based on a class name 762 shown in FIG. 6, an item name 794 that is quoted from item names 712, 722, and 732 shown in FIG. 4, and a code 795, quantity 796, and an accounting flag 797 that are quoted from a set slave code 743 shown in FIG. 5, quantity 746, and an accounting flag 744 respectively.

This operating information 790 is created on the basis of a set specified by a set master code “SET001” that is the only one code that is found by the retrieval on the basis of the article information 780 shown in FIG. 8. As shown in FIG. 5, five items are included in the set specified by the set master code “SET001”, and two items among the five items are items of “optional”. Since the user selects “needless” for these two items of “optional” here, only three items are included in the operating information 790.

In the above-described fundamental operation, so long as a medical doctor or a nursing staff who is a practicer of a medical practice makes a bar code read into the operating information management apparatus about a small number of consumables and performs the selection operation prompted by the operating information management apparatus, operating information is created almost automatically and is recorded. That is, a medical doctor or a nursing staff who is a user of the operating information management apparatus can simply and correctly create the operating information where all items required as record of the carried-out medical practice are filled. For this reason, a medical doctor and a nursing staff can centralize efforts on original activities.

In addition, although a user is prompted a selecting operation of a set in the above-described fundamental operation when a plurality of sets is found by the retrieval unit, the user may be prompted an input of another article information in the operating information management apparatus according to the present invention. In this case, a set is focused by further retrieval by the retrieval unit when another article information is inputted by the user.

Three application operations to the fundamental operation described above will be described below. Although the operating information management apparatus according to this embodiment performs complex operation that conceptually includes the above-described fundamental operation and three application operations described below, for convenience of explanation, assuming that each operation is independent of others, explanation will be performed.

The first application operation is an operation including an operating part of checking a consistency between a medical practice, included in a set found by retrieval, and a medical practice to be scheduled.

FIG. 10 is a diagram showing another example of inputted article information.

Although article information 800 shown in this FIG. 10 is the same as the article information 780 shown in FIG. 8 in the point that it is constituted by an item code 801 and an item name 802, the contents of the article information 800 shown in this FIG. 10 differ from those of the article information 780 shown in FIG. 8. The article information 800 shown in this FIG. 10 is article information that is constituted by an item code “300030” and an item name “heparin sodium”.

After a set is retrieved similarly to the above-described fundamental operation by receiving an input of such article information in the first application operation, a medical practice item is read into the information check unit 124, which is shown in FIG. 3, among items included in the set found by the retrieval. In this embodiment, an item whose set slave master class is “1 (=manipulation)” is an item of a medical practice.

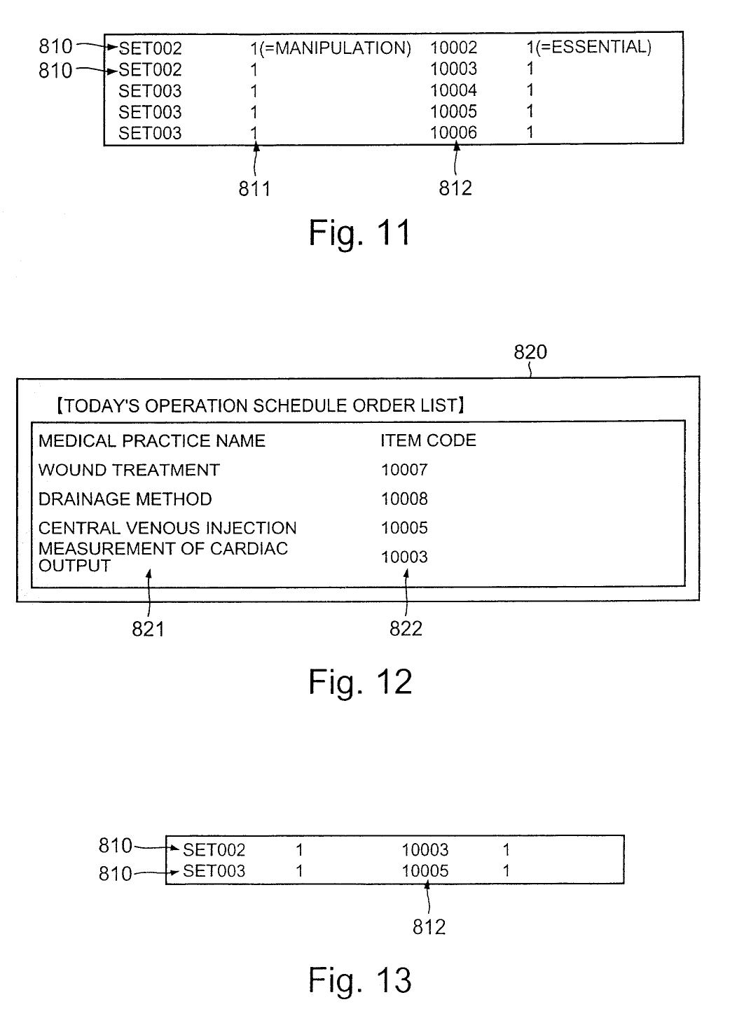

FIG. 11 is a diagram showing items that are read.

Five items 810 that are extracted from two sets specified by a set master code “SET002” and a set master code “SET003” are shown in this FIG. 11. Since a value of each set slave master class 811 of these five items 810 is “1” showing a class of a medical practice (manipulation), five item codes “10002”, “10003”, “10004”, “10005”, and “10006” specifying these five items 810 respectively are practice information showing medical practices.

When such items 810 are extracted and read from a set by the information check unit 124, schedule information where a medical practice to be performed is expressed in a list format is acquired from the schedule information storage apparatus 611 by the practice information acquisition unit 123 shown in FIG. 3. This schedule information is called an “order list” since being a list of medical practices whose execution is ordered by a medical doctor. In addition, here, it is assumed that the schedule information of a patient, specified by patient selection information 770 shown in FIG. 7, in that day is acquired.

FIG. 12 is a diagram showing an example of schedule information.

In this schedule information 820, a medical practice name 821 showing a medical practice, and an item code 822 which specifies a medical practice expressed in the medical practice name 821 are mentioned. This schedule information 820 shows that four medical practices are planned, and values of four item codes 822 are “10007”, “10008”, “10005”, and “10003”. Such schedule information is acquired by the practice information acquisition unit 123 shown in FIG. 3, and is sent to the information check unit 124.

In addition, the medical practice name 821 is for a user identifying a medical practice in the schedule information registration function 610 shown in FIG. 3 and generally an expression peculiar to the schedule information registration function 610. On the other hand, the item code 822 is common in the operating information management apparatus 100 and the schedule information registration function 610 shown in FIG. 3. Therefore, in the information check unit 124, the item code 822 is used as practice information.

The information check unit 124 that extracts the five items 810, shown in FIG. 11, from a set and receives the schedule information 820 shown in FIG. 12 collates the item code 812 of the extracted item 810 with the item code 822 mentioned by the acquired schedule information 820, and selects only the item 810 which has the item code 812 with the same value as the value of any one item code among the item codes 822 mentioned in the acquired schedule information 820 from the extracted items 810. Thereby, the items 810 (here, five items) shown in FIG. 11 are focused only into the item of a medical practice whose operation is planned.

FIG. 13 is a diagram showing an example of a selected item.

Two items 810 selected from the five items 810 shown in FIG. 11 are shown in this FIG. 13. Although values of respective item codes 812 of the five items 810 shown in FIG. 11 are “10002”, “10003”, “10004”, “10005”, and “10006”, values of respective item codes 822 mentioned in the schedule information 820 shown in FIG. 12 are “10007”, “10008”, “10005”, and “10003”. Hence, as shown in FIG. 13, two items 810 having the item codes 812 whose values are “10003” and “10005” are selected.

The two items 810 selected after passing such collating by the information check unit 124 belong to separate sets whose master codes are “SET002” and “SET003” here. For this reason, those sets are shown to a user through the output devices 220 and 320 shown in FIG. 3, and the selection of a target set is prompted by the user. The target set is specified by the selection, and on the basis of the specified set, operating information is created like the above-described fundamental operation. In addition, since the target set is specified if the set where the selected item belongs is one set, operating information is created on the basis of the specified set.

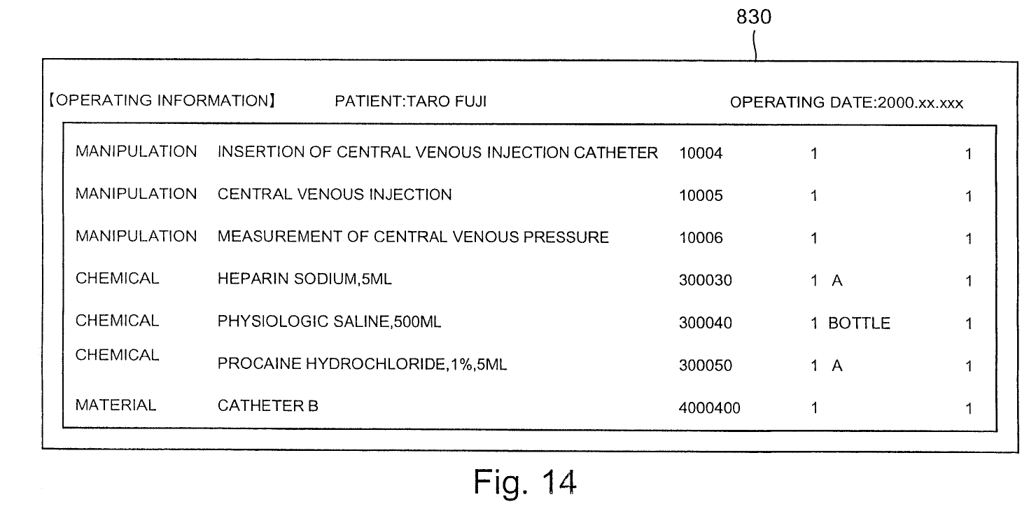

FIG. 14 is a diagram showing an example of operating information created in the first application operation.

Operating information 830 created when the set specified by the set master code “SET003” is selected is shown in this FIG. 14.

Three items having “manipulation” are mentioned by this operating information 830, and an item, having item code whose value is “10005”, among these three items is an item showing a medical practice that the operation was planned. In addition, two items, having item codes whose values are “10004” and “10006”, among the three items with “manipulation” which are mentioned in this operating information 830 show a medical practice performed in connection with a medical practice whose operation was planned.

Thus, since focusing into an adequate set is performed even if many sets are found in retrieval when collation of practice information is performed, it is easy to perform the selection of a set and the creation of operating information.

By the way, if any item does not pass the above-described collation by the information check unit 124 and no selected item exist, there is a possibility that a user's input mistake etc. arises, and hence, a caution is issued to the user through the output devices 220 and 320 shown in FIG. 3. That is, by collating the practice information, it is possible to find a user's input mistake etc. and to easily create the exact operating information.

However, in a medical site, it also often happens that another medical practice different from the scheduled medical practice is performed instead of the scheduled medical practice. For this reason, when a caution is issued, focusing into the practice information based on the schedule information is disregarded, and a user is prompted to perform a selection operation of a set like the above-described fundamental operation.

The description about the first application operation is ended above, and hereafter, a second application operation will be described. This second application operation is an operation including an operating part of checking a medical practice, included in a set found by retrieval, on the basis of a medical practice having been finished.

This second application operation is an operation that is the same as the first application operation described above, from article information being inputted to the retrieval of a set being performed, a medical practice item being read, schedule information being acquired, and a medical practice item being focused on the basis of the schedule information. However, hereafter, a case will be described as an example, the case that the article information 800 shown in FIG. 10 is inputted and schedule information different from the schedule information 820 shown in FIG. 12 is read.

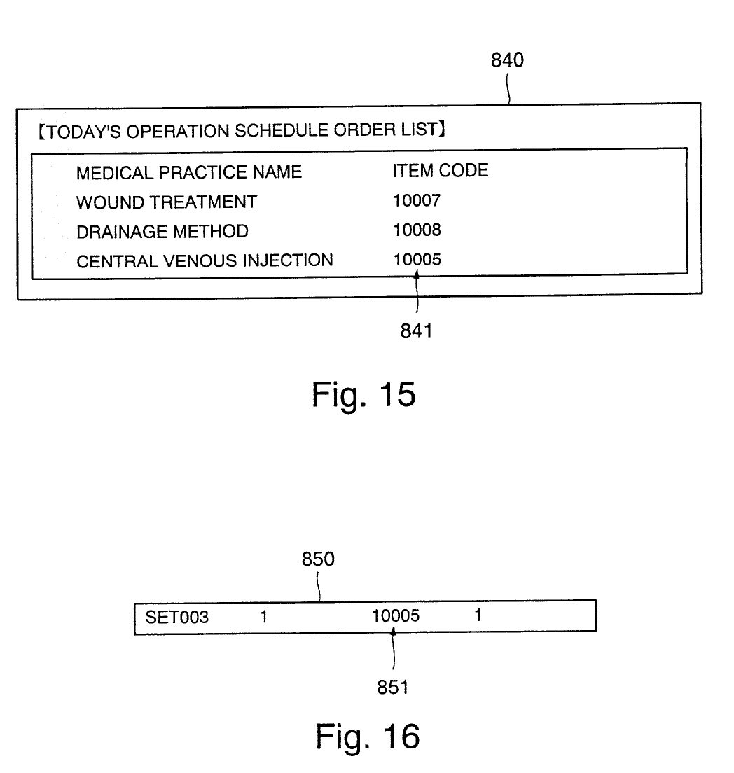

FIG. 15 is a diagram showing an example of schedule information.

Schedule information 840 showing that three medical practices are planned is shown in this FIG. 15, and the values of three item codes 841 mentioned in this schedule information 840 are “10007”, “10008”, and “10005”.

Here, the information check unit 124 shown in FIG. 3 receives the schedule information 840 shown in FIG. 15 while extracting five items 810 shown in FIG. 11 from a set, and the item codes of these five items 810 are collated with the item codes mentioned in the schedule information 840 like the above to select only the item 810 having an item code whose value corresponds to that in the schedule information 840.

FIG. 16 is a diagram showing another example of a selected item.

Only one item 850 is shown in this FIG. 16 as a selected item.

In the second application operation, when an item is selected in this way, the created operating information showing a medical practice having been finished is acquired by the practice information acquisition unit 123 shown in FIG. 3, and it is sent to the information check unit 124.

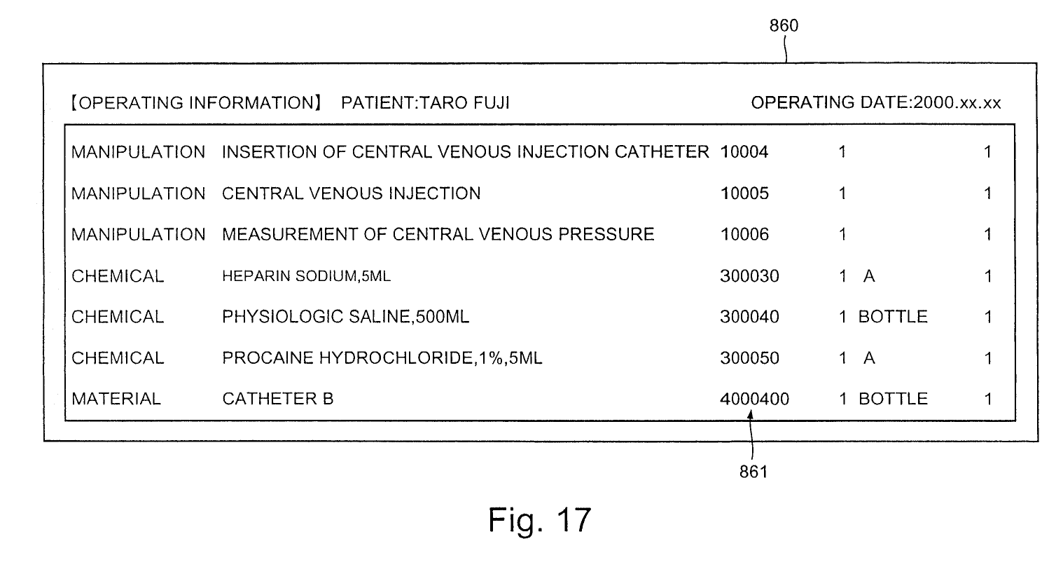

FIG. 17 is a diagram showing an example of created operating information.

The operating information 860 shown in this FIG. 17 is similar to the operating information 830 shown in FIG. 14.

When receiving the created operating information 860 as shown in this FIG. 17, the information check unit 124 collates the value of the item code 851 of the item 850 shown in FIG. 16 with the value of the item code 861 mentioned in the operating information 860. Since duplicated operation may be performed by a user's mistake when the same values exist, a caution is issued to the user through the output devices 220 and 320 shown in FIG. 3. In the case of the item 850 shown in FIG. 16, since an item code having a value that is the same as the value “10005” of the item code 851 is mentioned in the operating information 860 shown in FIG. 17, a caution is issued to the user.

Thus, by performing collating on the basis of the operating information showing a medical practice having been finished, a user's mistake can be found and the exact operating information can be created easily.

However, since a plurality of similar medical practices (for example, injection) may be performed in a day, the user who receives the caution can also direct the continuation of creation of the operating information in this embodiment. The operating information management apparatus to which such continuation is directed disregards the result of a check to create the operating information like the above-described first application operation and fundamental operation.

The description about the second application operation is ended above, and hereafter, a third application operation will be described. This third application operation is an operation including an operation part of evaluating (checking) a set, which is found by retrieval from a medical viewpoint on the basis of a check master stored in the check master storage unit 143 shown in FIG. 3.

In this third application operation, like the fundamental operation, first application operation, and second application operation, which are described above, article information is inputted and the retrieval of a set is performed. In addition, the following description will be performed like description of the first application operation and the second application operation, assuming that the article information 800 shown in FIG. 10 is inputted. Therefore, two sets specified by the set master codes whose values are “SET002” and “SET003” are found by the retrieval of sets by the retrieval unit 122 shown in FIG. 3.

The list of patient's disease names is acquired from the disease name information storage apparatus 621 by the information check unit 124 after such retrieval of a set.

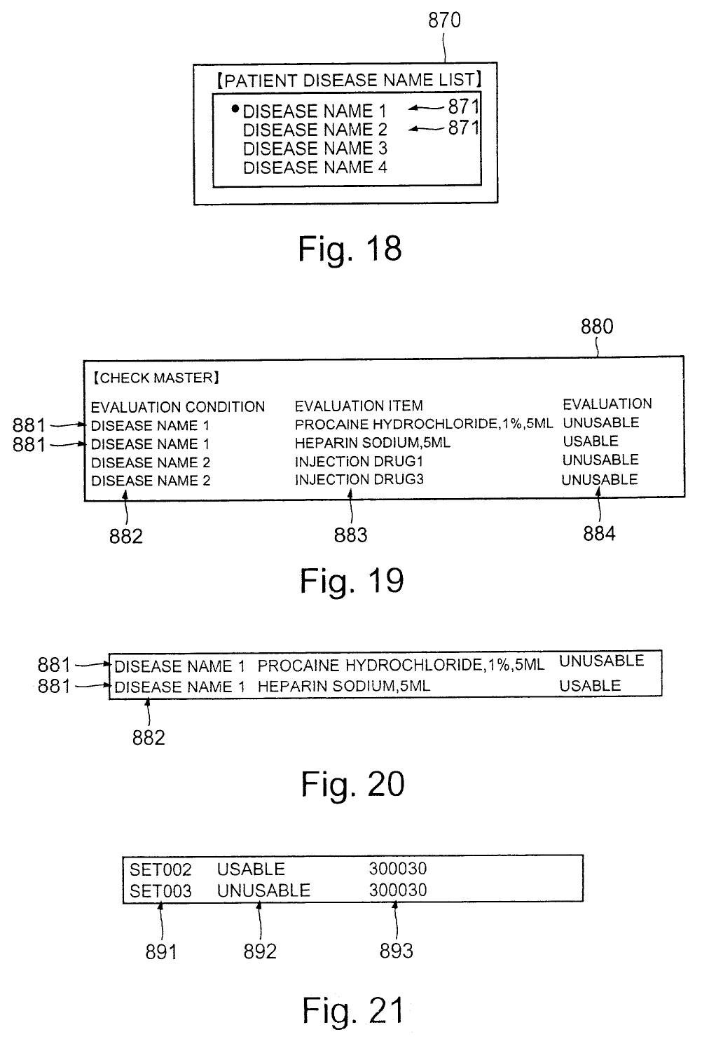

FIG. 18 is a diagram showing a list of disease names.

Names 871 of diseases that are registered as diseases that the patient caught are mentioned in this list 870. This list 870 is shown to a user such as a medical doctor or a nursing staff through the output devices 220 and 230 shown in FIG. 3. The user selects a name of a disease, which the patient presently catches, out of this list 870. Here, the following description will be performed as an example assuming that a “disease name 1” is selected.

When a disease name is selected by the user, a record corresponding to the selected disease name is read from the check master stored in the check master storage unit 143, by the information check unit 124 shown in FIG. 3.

FIG. 19 is a diagram showing an example of a check master.

As described above, indices for performing a medical information check are mentioned in the check master.

A check master 880 including four records 881 is shown as an example in this FIG. 19, and each of the records 881 denotes a medical index. Each record 881 is constituted by an evaluation condition 882 determining whether the record is used for evaluation of a set, an evaluation item 883 that becomes an evaluation object among items included in the set, and contents 884 of an evaluation to the set. In this check master 880, a disease is adopted as an evaluation condition 882, a chemical is adopted as an evaluation item 883, and each record 881 denotes the passage or rejection of use of a predetermined chemical to a certain disease.

The record 881 including the evaluation condition 882 of the disease name coinciding to the disease name, which the user selected, among the records 881 included in this check master 880 is read, and is used for evaluation.

In addition, in the check master storage unit 143 shown in FIG. 3, a check master where a chemical name etc. are adopted in both of the evaluation condition and evaluation item may be stored as indices showing medical interactions of chemicals. When such a check master is stored, a record corresponding to the item of a chemical included in a set found in retrieval is read.

Hereafter, description of the operation in the case that the check master where a disease name is adopted as an evaluation condition is stored will be continued.

FIG. 20 is a diagram showing an example of a record read from a check master.

As described above, in response to user's selection of “disease name 1”, two records whose evaluation conditions 882 are “disease name 1” are read from the check master 880 shown in FIG. 19.

When reading a record from the check master in this way, the information check unit 124 shown in FIG. 3 collates an item included in a set found in retrieval by the retrieval unit 122 with an evaluation item of the record, and if the item which coincides with the evaluation item is included in the set, the “contents of evaluation” included in the record is made the evaluation to the set. In addition, if two or more records whose items correspond with one set exist, the most important “contents of evaluation” is made the evaluation to the set among the “contents of evaluation” of each record.

FIG. 21 is a diagram showing the evaluation result of a set.

The evaluation of a set is shown by the combination of a set master code 891 showing an evaluated set, content 892 of evaluation, and an item code 893 showing an item used as an index of evaluation.

Here, an item of a chemical “HEPARIN SODIUM, 5ML” expressed in an item code “300030” is included in a set with a set master code whose value is “SET002”, the content of the evaluation to this set becomes “usable”. In addition, in a set with a set master code whose value is “SET003”, an item of a chemical “HEPARIN SODIUM, 5ML” expressed in an item code “300030”, an item of a chemical “PROCAINE HYDROCHLORIDE, 1%, 5ML” expressed in an item code “300050” are included, and hence, the contents of the evaluation to this set becomes “unusable”.

Therefore, the information check unit 124 shown in FIG. 3 determines that only the set with a set master code, whose value is “SET002”, between two sets found in retrieval is a medically adequate set, and sends information on this set to the operating information creation unit 125.

Thus, exact operating information is easily created by performing the medical check by the check master.

Operating information created by the fundamental operation, and the first, second, and third application operations, which are described above, in the operating information processing unit 120 shown in FIG. 3 is stored in the first operating information storage unit 144 as undetermined operating information. Then, while reading the undetermined operating information and creating medical accounting supply information on the basis of the undetermined operating information, the accounting information processing unit 130 determines the operating information.

Hereafter, the operation of medical accounting supply information being created by the accounting information processing unit 130 will be described. This accounting information processing unit 130 creates the medical accounting supply information by using the read operating information and medical linkage information prepared beforehand.

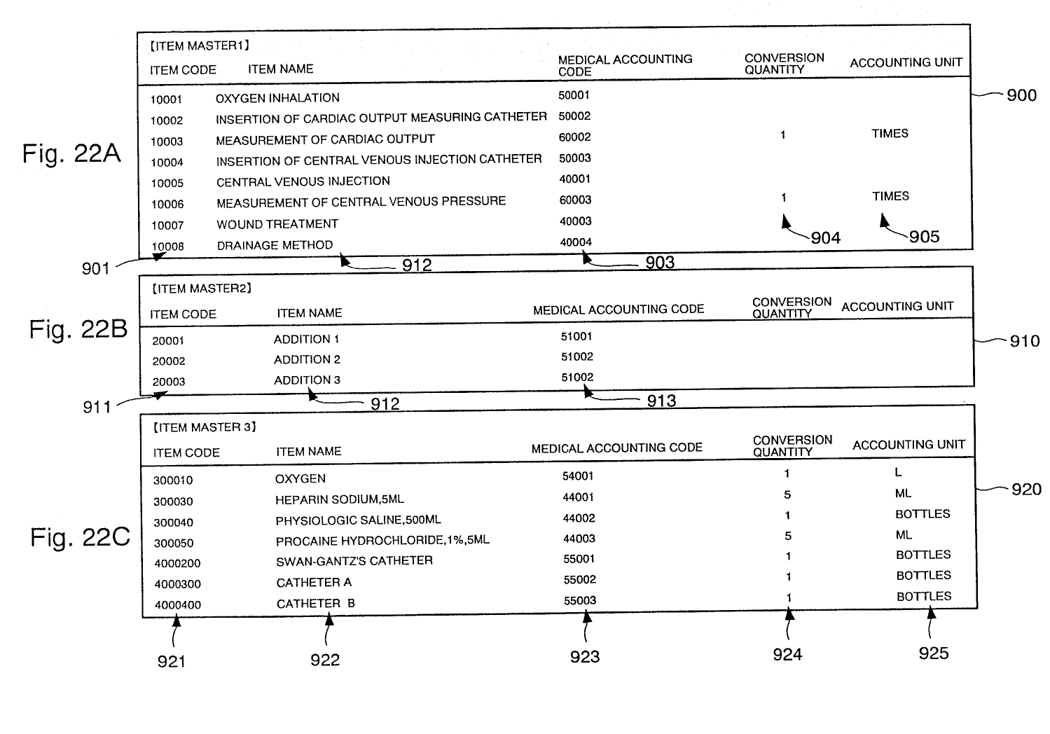

FIGS. 22A to 22C are diagrams showing examples of medical linkage information.

Three types of medical linkage information corresponding to three item masters shown in FIGS. 4A to 4C respectively is shown in these FIGS. 22A to 22C, that is, FIG. 22A shows medical linkage information 900 corresponding to the item master 710 of a medical practice (manipulation), FIG. 22B shows medical linkage information 910 corresponding to the item master 720 of medical remuneration addition items, and FIG. 22C shows medical linkage information 920 corresponding to the item master 730 of articles. In this embodiment, these three types of medical linkage information 900, 910, and 920 are stored in the medical linkage information storage unit 145 shown in FIG. 3.

In these medical linkage information 900, 910, and 920, information for medical accounting processing about items, mentioned in the operating information, such as a medical practice and an article is mentioned in a list format. In each of these types of medical linkage information 900, 910, and 920, item codes 901, 911, and 921, and item names 902, 912, and 922 like the item codes 711, 721, and 731, and the item names 712, 722, and 732, which are shown in FIG. 4, are mentioned. In addition, in each of these types of medical linkage information 900, 910, and 920, medical accounting codes 903, 913, and 923 for specifying items, such as medical practice and an article, in medical accounting are also mentioned. Furthermore, in each of two types of medical linkage information 900 and 920 shown in FIGS. 22A and 22C, accounting units 905 and 925 and conversion quantities 904 and 924 at the time of calculating the remuneration for respective items such as a medical practice, and an article are also mentioned.

The accounting information extraction unit 131 of the accounting information processing unit 130 shown in FIG. 3 receives operating information read from the first operating information storage unit 144, and extracts records from the medical linkage information 900, 910, and 920 as shown in this FIG. 22 on the basis of the operating information.

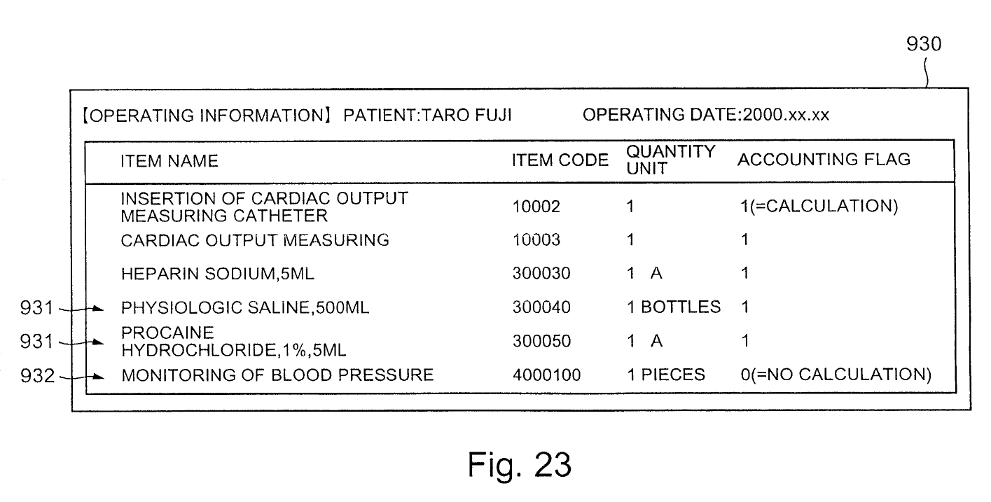

FIG. 23 is a diagram showing an example of operating information read into the accounting information processing unit.

A format of this operating information 930 is the same as the format described in FIG. 9.

In this operating information 930, five items 931 with accounting flags whose values are “1” showing the calculation of medical remuneration are mentioned, and one item 932 with an accounting flag whose value is “0” showing the no calculation of medical remuneration is mentioned.

When receiving such operating information 930, the accounting information extraction unit 131 shown in FIG. 3 extracts a record, which has the same item codes 901, 911, and 921 as the item codes of the item, from the medical linkage information 900, 910, and 920, which is shown in FIG. 22, only for an item with accounting flag whose value is “1”. Then, the accounting information extraction unit 131 sends the extracted record and the above-described operating information to the supply information creation unit 132 shown in FIG. 3.

The supply information creation unit 132 adds a medical accounting code corresponding to an item with accounting flag, whose value is “1”, among the items mentioned in the operating information 930, and converts the quantities and units mentioned in the operating information 930 into quantities and units for medical accounting on the basis of the accounting units 905 and 925 and the conversion quantities 904 and 924 which are shown in FIG. 22. The medical accounting supply information is created as described above.

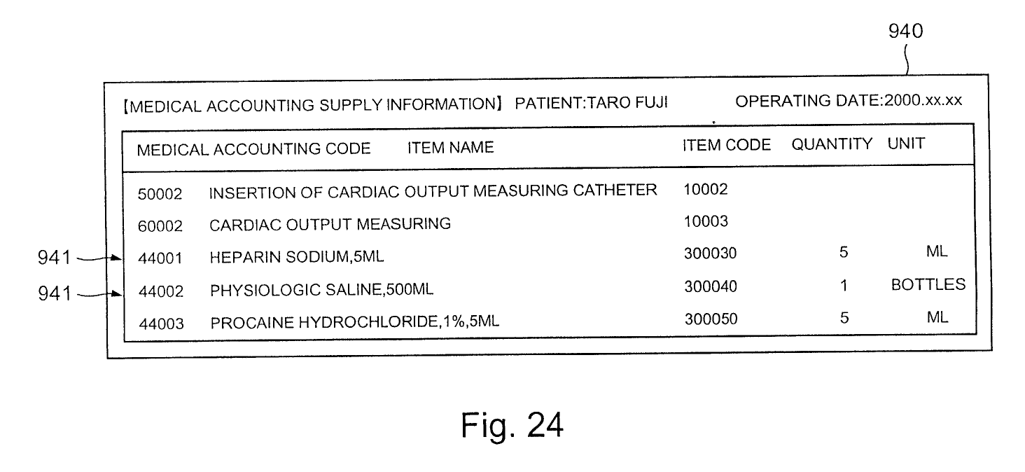

FIG. 24 is a diagram showing an example of medical accounting supply information.

This medical accounting supply information 940 is created on the basis of the operating information 930 shown in FIG. 23, and is constituted by only five items 941 corresponding to the five items 931 with accounting flags whose values are “1”.

Thus, the medical remuneration is obtained correctly and easily by creating the medical accounting supply information 940 based on the operating information 930 and medical linkage information 900, 910, and 920. Since the exact operating information which has a sufficient amount of information by the fundamental operation or application operations described above is created, the exact medical accounting supply information 940 is created, and exact accountancy is realized.

In the above described embodiment, there are the corresponding accounting flags for both the practice information and article information so that both the information representing a medical practice or article, for which remuneration can be claimed, are extracted from the operating information. However, the information extraction unit according to the present invention may extract only the information on an article, for which remuneration can be claimed, from the operating information, or may extract only the information on a medical practice, for which remuneration can be claimed, from the operating information.

What is claimed is:

1. An operating information management apparatus which manages operating information showing operation contents of a medical practice, comprising:
an information set storage unit storing an information set including practice information showing a medical practice, and article information showing the article consumed in connection with the medical practice;
an article information input unit into which arbitrary article information showing an article consumed in connection with a medical practice is inputted;
an information set retrieval unit retrieving an information set including the same article information as the article information inputted into the article information input unit among information sets stored in the information set storage unit; and
an operating information creation unit creating operating information based on article information and practice information that is included in an information set retrieved by the information set retrieval unit.

2. The operating information management apparatus according to claim 1, further comprising:
a practice information acquisition unit acquiring the practice information from a predetermined information source; and
a practice information collating unit collating practice information included in an information set retrieved by the information set retrieval unit, with practice information acquired by the practice information acquisition unit.

3. The operating information management apparatus according to claim 1, further comprising an information extraction unit extracting at least either one of article information and practice information that show an article and a medical practice respectively, for which remuneration can be claimed, from article information and practice information that are included in an information set retrieved by the information set retrieval unit.

4. An operating information management program storage medium that stores an operating information management program that is built in a computer and makes the computer operate as an operating information management apparatus which manages operating information showing operation contents of a medical practice, wherein the operating information management program storage medium stores an operating information management program which makes a computer operates as an operating information management apparatus that comprises:
an information set storage unit storing an information set including practice information showing a medical practice, and article information showing an article consumed in connection with the medical practice;
an article information input unit into which arbitrary article information showing an article consumed in connection with a medical practice is inputted;
an information set retrieval unit retrieving an information set including the same article information as the article information inputted into the article information input unit among information sets stored in the information set storage unit; and
an operating information creation unit creating operating information based on article information and practice information that is included in an information set retrieved by the information set retrieval unit.
